(19) United States
(12) Patent Application Publication
(10) Pub. No.: US 2011/0103767 A1
(43) Pub. Date: May 5, 2011

(54) TIME DEPENDENT REPLACEMENT OF STORED BROADCAST CONTENT

(76) Inventor: Andrew G. Setos, Pacific Palisades, CA (US)

(21) Appl. No.: 12/735,566

(22) PCT Filed: Apr. 10, 2008
(86) PCT No.: PCT/US2008/059852

§ 371 Date: Dec. 21, 2010

Related U.S. Application Data
(60) Provisional application No. 60/910,957, filed on Apr. 10, 2007.

(51) Int. Cl. H04N 9/80

(52) U.S. Cl. 386/248; 386/E05.001

(57) ABSTRACT

A method for time dependent replacement of stored broadcast content, wherein such method replaces a time period of broadcast as a function of how many minutes, hours, days, weeks or months have elapsed since the initial broadcast or whether a predetermined date has passed.

### BACKGROUND

A common and pervasive problem with stored broadcast content, particularly with broadcast content recorded client-side for future playback, is that certain content becomes outdated as time passes. For example, one or more advertisements may anticipate events that, at the time of playback, have already occurred. Other exemplary content, which has the potential to become outdated, includes openings and endings of scripted programs, public service announcements, commercial announcements, weather advisories and traffic advisories, among others.

People viewing content are acutely aware of outdated broadcast content. These outdated segments become dead space, not just with regard to entertainment value to the observer, but also with regard to the value of the segment. For example, it is detrimental to lose advertising effectiveness of a captive audience when such segments become outdated. Observers will fast forward, find ways to delete the commercials, or walk away from the viewing.

What is needed in the art are effective mechanisms for preventing such broadcast segments from losing value and for preventing disinterest of the observer.

### SUMMARY

The above-described and other problems and deficiencies of the prior art are overcome and alleviated by the presently described method for time dependent replacement of stored broadcast content. In an exemplary embodiment, such method replaces a time period of broadcast as a function of how many minutes, hours, days, weeks or months have elapsed since the initial broadcast or whether a predetermined date has passed. In an exemplary embodiment, a file, which may be part of the broadcast content, may be stored separately or may be subsequently broadcast or downloaded, describes one or more of: the content elements or segments to be replaced within the stored broadcast; the time period for replacing one or more of such elements or segments as a matter of dead reckoning or elapsed time from the broadcast start; various content elements or segments for replacing such elements or segments from the initial broadcast; and indication of the initial broadcast date, an indication of elapsed time from the initial broadcast date or indication of a time (minute, hour, date, etc.) for replacing one or more such elements or segments.

The above-discussed and other features and advantages of the presently described time dependent replacement of stored broadcast content will be appreciated and understood by those skilled in the art from the following detailed description and drawings.

### BRIEF DESCRIPTION OF THE DRAWINGS

Referring now to the drawings, wherein like elements are numbered alike in the following FIGURE:

FIG. 1 is an exemplary flowchart illustrating storage of broadcast content along with a file and future replacement of segments within said broadcast content.

### DETAILED DESCRIPTION OF EXEMPLARY EMBODIMENTS

Reference will now be made in detail to exemplary embodiments, examples of which are illustrated by the accompanying drawing.

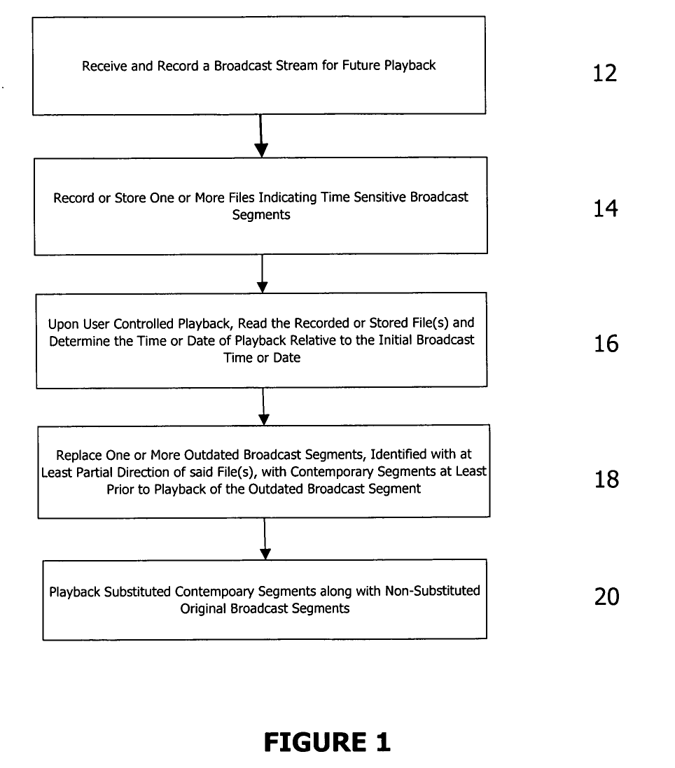

Referring now to FIG. 1, an exemplary method for time dependent broadcast segment replacement is illustrated. The illustrated exemplary embodiment relates to receiving a broadcast stream and recording (storing) of at least a portion of such stream for future playback (see box 10). The broadcast stream includes at least one time-sensitive segment, such as an advertisement, promotion or event that refers to a particular date or that expires on a particular date. In this embodiment, one or more files is also stored, which file somehow indicating that at least one time sensitive segment exists (see box 14). The playback device or an associated device accesses such file upon user controlled playback and determines whether one or more segments should be replaced at least in part upon the information in the file (see box 16).

The device may, e.g., identify an expiration date of a segment and compare such expiration date with the current playback date. In another embodiment, the file may identify the broadcast date of one or more segments, and the device, either on its own or with the direction of the file, may replace one or more segments if such broadcast date is beyond a certain predetermined time limit (e.g., hours, days, weeks, months, a particular date). In other exemplary embodiments, the file may also describe one or more of: the content elements or segments to be replaced within the stored broadcast; the time period for replacing one or more of such elements or segments as a matter of dead reckoning or elapsed time from the broadcast start; various content elements or segments for replacing such elements or segments from the initial broadcast; and indication of the initial broadcast date, an indication of elapsed time from the initial broadcast date or indication of a time (hour, date, etc.) for replacing one or more such elements or segments.

As is illustrated at box 18, after the device indicates that at least one time sensitive segment exists, the device replaces the one or more segments with contemporary segments. The replacement contemporary segments may be downloaded, broadcast or retrieved from storage. The device may also replace all outdated segments prior to playback, or the device may simply replace an outdated segment at some point before playback of the outdated segment (see box 18 and 20).

In an exemplary embodiment, a file may be sent once or multiple times with updated information. Such file may also be sent, downloaded or broadcast before, during or after the initial broadcast. Storage of the file need not be local, but may also be at a central server in a client/server environment or at a distributed server including a server within the consumer's premises.

Either the file, if it is used, and/or the broadcast, if they are to be stored locally, may be placed on any convenient device, including a hard drive or flash drive (e.g., on a computer or set top box), a digital video recorder (DVR) a VCR, a DVD media or the like. Likewise contemporary segments for replacing the outdated segments may be stored on the same and/or may be pulled periodically from one or more subsequent broadcast streams, or downloaded up and until the device calls for replacement of a segment.

Exemplary types of segments that may be time sensitive include, but are not limited to (by example only and without limitation): openings and endings of scripted programs; public service announcements; promotional announcements; commercial announcements; weather advisories; and traffic advisories, among others.

In another exemplary embodiment, the device may replace all of at least one type of segments after a certain period of time has lapsed from the broadcast date or after a specified date. For example, with or without a separately stored file, the device may identify the broadcast date of the recorded broadcast and compare that date with the current playback date. If the broadcast recording has expired, all of at least one particular segment type (e.g., all advertisements) are replaced, at least before each of those segments are played back.

It will be apparent to those skilled in the art that, while exemplary embodiments have been shown and described, various modifications and variations can be made to the time dependent broadcast segment replacement method disclosed herein without departing from the spirit or scope of the invention. Accordingly, it is to be understood that the various embodiments have been described by way of illustration and not limitation.

What is claimed is:

1. A method for time dependent replacement of stored broadcast content, comprising:
receiving and storing a broadcast steam on a storage device for future playback;
identifying to said device or by said device one or more time sensitive segments within said stored broadcast stream;
upon user controlled playback, said device determining whether at least one of said one or more time sensitive segments has expired or is outdated; and
replacing said one or more segments with a contemporary segment before playback of said expired or outdated segment.

2. A method in accordance with claim 1, wherein said method replaces a time period of broadcast as a function of how many minutes, hours, days, weeks or months have elapsed since the initial broadcast or by whether a predetermined date has passed.

3. A method in accordance with claim 2, wherein a file is stored or received describing one or more of: segments to be replaced within the stored broadcast; a time period for replacing one or more of such segments as a matter of dead reckoning or elapsed time from the broadcast start; various segments for replacing expired or outdated segments from the initial broadcast; and indication of the initial broadcast date, an indication of elapsed time from the initial broadcast date or indication of a time or date for replacing one or more such elements or segments.
